(19) United States
(12) Patent Application Publication
(10) Pub. No.: US 2016/0181773 A1
(43) Pub. Date: Jun. 23, 2016

(54) STRIPPING TOOL FOR ROUND CABLES WITH THIN INSULATION

(71) Applicant: KRAMPE Immobilien GmbH & Co. KG, Ascheberg - Herbern (DE)

(72) Inventor: Carsten BUENNIGMANN, Ascheberg - Herbern (DE)

(73) Assignee: KRAMPE Immobilien GmbH & Co. KG, Ascheberg - Herbern (DE)

(21) Appl. No.: 14/963,343

(22) Filed: Dec. 9, 2015

(30) Foreign Application Priority Data
Dec. 18, 2014 (DE) 20 2014 106 142

(51) Int. Cl. H02G 1/12

(52) U.S. Cl. CPC H02G 1/1224

(57) ABSTRACT

A stripping tool for the removal of the insulation of single-wire or multi-wire cables joins two jaws with one another via a common hinge pin as a hinged hollow body for the accommodation of the cable to be stripped and on one end face of which cutters are provided for a circumferential cut of the insulation close to the end of the cable. At the end of the hollow body opposite the cutters, behind an opening in the jaws, a cushion is respectively incorporated between which the end of the cable can be clamped with the outer insulation severed by the circumferential cut and thus the portion of the outer insulation can be stripped from the cable.

### CROSS REFERENCE TO RELATED APPLICATIONS

Applicant claims priority under 35 U.S.C. §119 of German Application No. 20 2014 106 142 U1, filed Dec. 18, 2014, the disclosure of which is incorporated by reference.

### BACKGROUND OF THE INVENTION

1. Field of the Invention

The invention relates to a stripping tool for the removal of the insulation of one-wire or multi-wire cables by two jaws. The jaws are joined with one another via common hinge pins as a hollow body for the accommodation of the cable to be stripped and on one end face of which cutters are provided for a circumferential cut of the insulation close to the end of the cable.

2. Description of the Related Art

Standardized cables, which have a very thin, firmly adhering outer insulation are being increasingly used in industrial automation for control tasks. Such an insulation is manufactured from heat-resisting plastic, which conforms firmly around the inner shielding of the wires of the cable. For the stripping of the outer insulation, tools must be used that permit a very shallow circumferential cut, in order not to damage the inner shielding. After the circumferential cut, the outer insulation still adheres firmly to the shielding or to the wires and can be pulled off only with difficulty.

For the removal of the insulation sheath from cables, a stripping tool that consists of two jaws, which are joined with one another via common hinge pins as a hinged hollow body for the accommodation of the cable to be stripped and on one end face have cutters for a circumferential cut, is known from Utility Model DE 298 14 771 U1. The tool is not suitable for safely cutting and then stripping thin, firmly adhering insulations.

A stripping device for cable wires is provided in the tool according to patent application DE 38 08 950 A1 comprising a hollow body with two jaws. The device consists of knife blades, which are mounted at the end face of the jaws. A cutting of thin insulations is hardly possible, and no aid for stripping of the insulation is provided.

### SUMMARY OF THE INVENTION

The task of the invention was to disclose a stripping tool with which circumferential cuts can be made cleanly in thin insulations and which provides a help for the stripping of the cut insulation.

This task is accomplished by the features according to the invention. Further particulars and advantages of the invention are set forth in more detail below.

The stripping tool for the removal of the insulation of one-wire or multi-wire cables has two jaws, which are joined with one another via common hinge pins as a hinged hollow body for the accommodation of the cable to be stripped. The end faces of the jaws are equipped with cutters for a circumferential cut of the insulation, which is made close to the end of the cable.

At the end of the hollow body opposite the cutters, behind an opening in the jaws, the stripping tool respectively incorporates a cushion, between which the end of the cable can be clamped with the insulation severed by the circumferential cut. When the cable end is clamped between the cushions before the circumferential cut by pressing the jaws together, the insulation can be easily stripped from the cable.

The cutters are advantageously designed as straight blades, which are fixed in the jaws at a distance that corresponds to an inside diameter of the cable. Thereby, during the circumferential cut, an inner shielding of the cable disposed thereunder is not damaged. For a safer circumferential cut, a guide cavity, the opening of which corresponds to an outside diameter of the cable, is provided on one of the two blades. Thus the cable is cleanly guided during the circumferential cut.

The cushions advantageously have a flat, elongated shape, on which the cable end is placed. During the pressing together of the jaws, the insulation of the cable is held firmly between the cushions and the wires can be pulled out.

The cushions are favorably made of rubber, although silicone or other foamed substances may also be used.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a view of the stripping tool in the opened condition.

FIG. 2 shows a front view of the end face in the opened condition.

FIG. 3 shows a front view of the opening end in the opened condition.

FIG. 4 shows a view in the opened condition with inserted cable.

FIG. 5 shows a view in the closed condition with inserted cable.

FIG. 6 shows a front view of the end face in the closed condition with cable.

FIG. 7 shows a front view of the opening end in the closed condition with cable.

### DETAILED DESCRIPTION OF PREFERRED EMBODIMENTS

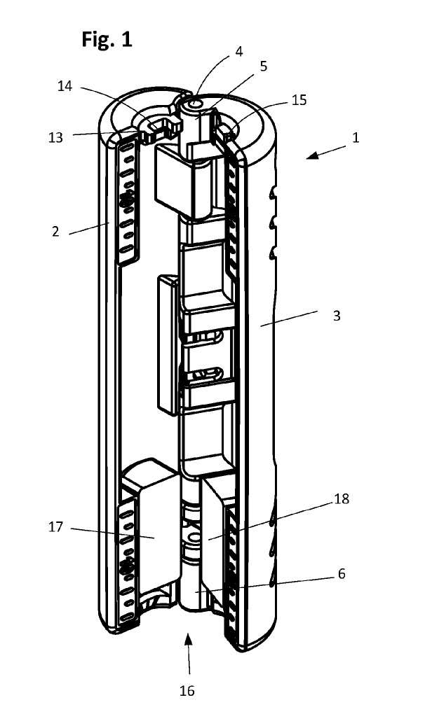

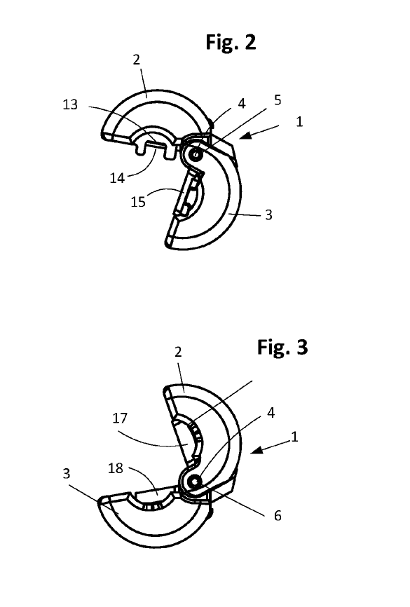

In FIG. 1, FIG. 2 and FIG. 3, the stripping tool 1 is illustrated in known basic form. The jaws 2, 3 have in cross section a partly cylindrical shape and on neighboring long sides they connect the hinge pins 4 in the form of hinges 5, 6. Via the hinge pins 4, the jaws 2, 3 can be closed together as a hollow body. To lay the cable wires bare it is necessary to remove the outer insulation of the cable. For this purpose the striping tool 1 possesses cutters 14, 15 in the jaws 2, 3, directly at the end face (FIG. 2). A cable disposed in the guide cavity 13 with closed jaws 2, 3 is subjected to the circumferential cut by means of the cutters 14, 15 during the turning of the stripping tool 1 around the cable wires. Thereafter a stripping of the outer insulation is still necessary for the complete separation of the outer insulation. For this purpose the stripping tool 1 is additionally equipped with respectively a cushion 17, 18 in the jaws 2, 3. They are disposed at the end of the jaws 1, 2 opposite the cutters 14, 15, beside the opening 16 (FIG. 3). It will obviously be understood that, instead of the turning of the stripping tool 1 by 180°, the cable may also be turned. By the arrangement of the cutters 14, 15 in the guide cavity 13, it is assured that the circumferential cut can be made with slight exertion of force.

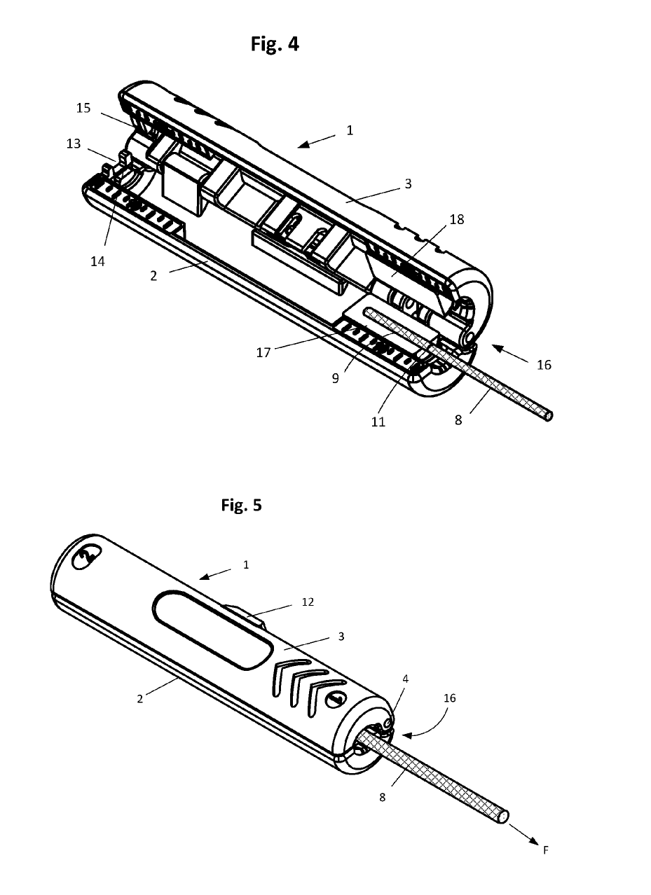

FIG. 4 and FIG. 5 show the stripping tool 1 in the opened and closed condition. Cushions 17 and 18, with which the cable 8 is clamped, are disposed on the jaws 2 and 3. For this purpose the cable 8 is placed in such a way on one cushion 17 at the opening 16 that the outer insulation 9 severed with the circumferential cut 11 is clamped between the cushions 17 and 18 when the jaws 2, 3 are closed together. By the pulling on the cable 8 the outer insulation 9 is stripped from the cable 8 and thus the wires or the shielding are or is laid bare. Via the lock 12 the stripping tool 1 can be held in closed position.

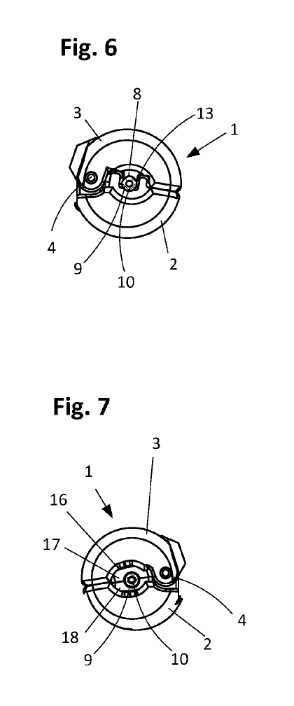

In FIG. 6 and FIG. 7, the situation of the cable 8 is illustrated respectively at the end face of the stripping tool 1 or at the opening end. The jaws 2, 3 are closed together around the hinge pin 4. At the end face, the cable 8 rests in the guide cavity 13 (FIG. 6) and the cutters, which are not visible here, sever the outer insulation 9 down to the core 10 of the cable 8. According to FIG. 7, the cable 8 is clamped in the opening 16 between the cushions 17 and 18 and the outer insulation 9 can be stripped from the core 10.

Although only a few embodiments of the present invention have been shown and described, it is to be understood that many changes and modifications may be made thereunto without departing from the spirit and scope of the invention.

What is claimed is:

1. A stripping tool for removing insulation of a single-wire or multi-wire cable comprising:
(a) a hinged hollow body for accommodation of the cable to be stripped, said hollow body comprising first and second jaws and a common hinge pin joining the first and second jaws;
(b) first and second cutters provided on a first end of the hollow body for a circumferential cut of the insulation close to an end of the cable; and
(c) first and second cushions provided on a second end of the hollow body opposite the first end behind an opening in the first and second jaws for clamping the end of the cable with the insulation severed by the circumferential cut between the first and second jaws and thereby stripping a portion of the insulation from the cable.

2. The stripping tool according to claim 1, wherein the first and second cutters are straight first and second blades, respectively, fixed in the jaws at a distance that corresponds to an inside diameter of the cable.

3. The stripping tool according to claim 2, wherein the first blade is fixed in a guide cavity having an opening corresponding to an outside diameter of the cable.

4. The stripping tool according to claim 1, wherein the cushions have a flat, elongated shape.

5. The stripping tool according to claim 4, wherein the cushions are made of a rubber.
